(19) United States
(12) Patent Application Publication
(10) Pub. No.: US 2024/0417037 A1
(43) Pub. Date: Dec. 19, 2024

(54) BOIL-OFF GAS RELIQUEFACTION SYSTEM AND METHOD FOR SHIP

(71) Applicant: HANWHA OCEAN CO., LTD., Geoje-Si, Gyeongsangnam-do (KR)

(72) Inventors: Ju Woon PARK, Incheon (KR); Seon Jin KIM, Siheung-si, Gyeonggi-do (KR); Won Jae CHOI, Siheung-si, Gyeonggi-do (KR)

(21) Appl. No.: 18/700,538

(22) PCT Filed: Dec. 27, 2021
(86) PCT No.: PCT/KR2021/019904

§ 371 Date: Apr. 11, 2024

(30) Foreign Application Priority Data
Oct. 28, 2021 (KR) 10-2021-0145491

(51) Int. Cl. B63B 25/16; F17C 6/00; F17C 9/02

(52) U.S. Cl. CPC B63B 25/16; F17C 6/00; F17C 9/02; F17C 2265/037; F17C 2270/0105

(57) ABSTRACT

A boil-off gas reliquefaction system includes: a compressor compressing boil-off gas generated from liquefied gas stored in a storage tank in a ship; a reliquefaction line connecting the compressor to the storage tank and allowing the boil-off gas to be reliquefied and returned to the storage tank therealong; a heat exchanger disposed on the reliquefaction line and cooling the boil-off gas compressed by the compressor; a separator disposed on the reliquefaction line, separating the boil-off gas cooled by the heat exchanger into a gaseous phase and a liquid phase, and supplying separated liquefied gas to the storage tank; a nitrogen blanket line along which nitrogen is supplied to an upstream side of the separator; and a bypass line branched from of the reliquefaction line downstream of the heat exchanger and connected to the storage tank without passing through the separator.

### TECHNICAL FIELD

The present invention relates to a boil-off gas reliquefaction system and method for cooling and reliquefying boil-off gas (BOG) generated from liquefied gas stored in a storage tank in a ship, which can ensure smooth delivery of liquefied gas separated by a separator to the storage tank by maintaining a constant pressure in the separator through supply of nitrogen to the separator and allows subcooled liquefied gas to be delivered to the storage tank without passing through the separator when the nitrogen is excessively dissolved in liquefied gas.

### BACKGROUND ART

Natural gas contains methane as a main component and has been attracting attention as an eco-friendly fuel that emits little or no environmental pollutants during combustion. Liquefied natural gas (LNG) is obtained by liquefying natural gas through cooling to about −163° C. under normal pressure and is suited to long-distance transportation by sea since it has a volume of about 1/600 that of natural gas in a gaseous state. Accordingly, natural gas is stored and transported as liquefied natural gas, which is easy to store and transport.

Since natural gas is liquefied at a cryogenic temperature of −163° C. under normal pressure, LNG storage tanks are typically insulated to maintain LNG in a liquid state. However, despite being insulated, such a storage tank is limited in ability to block external heat. Accordingly, due to external heat continuously transferred to the LNG storage tank, LNG stored in the LNG tank continues to evaporate naturally during transportation, causing generation of boil-off gas (BOG).

Continuous production of boil-off gas in the LNG storage tank increases the internal pressure of the LNG storage tank. If the internal pressure of the storage tank exceeds a predetermined safe pressure, this can cause an emergency situation such as rupture of the storage tank. Accordingly, there is a need to discharge boil-off gas from the storage tank using a safety valve. However, boil-off gas is a kind of LNG loss and is an important issue for transportation efficiency and fuel efficiency of LNG. Therefore, various methods are employed to handle boil-off gas generated in the LNG storage tank.

Recently, a method of using boil-off gas at a fuel demand site such as an engine of a ship, a method of reliquefying boil-off gas and returning the reliquefied boil-off gas to an LNG storage tank, and a method combining these two approaches have been developed and put into use.

### DISCLOSURE

### Technical Tasks

Methods for reliquefying boil-off gas include a method of reliquefying boil-off gas through heat exchange with refrigerant through a refrigeration cycle using separate refrigerant, a method of reliquefying boil-off gas using the boil-off gas itself as refrigerant without separate refrigerant, and the like.

As the method of reliquefying boil-off gas using the boil-off gas itself as refrigerant without separate refrigerant, a partial reliquefaction system (PRS) and an improvement thereof have been developed and used in ships, wherein, in the partial reliquefaction system, compressed boil-off gas is cooled through heat exchange with uncompressed boil-off gas and is adiabatically expanded to be reliquefied.

A boil-off gas reliquefaction system using a separate refrigeration cycle includes a reliquefaction process using nitrogen refrigerant.

Despite relative inefficiency compared to a reliquefaction cycle using a mixed refrigerant, such a reliquefaction cycle using nitrogen refrigerant is safer due to inert properties of nitrogen refrigerant and is easier to apply to ships since nitrogen refrigerant undergoes no phase change.

Boil-off gas cooled by cold heat from the boil-off gas itself or a separate refrigerant is introduced into a separator to be subjected to gas/liquid separation, and separated reliquefied gas is returned to a storage tank.

However, during normal operation of a reliquefaction system, liquefied gas subcooled through heat exchange can be introduced into the separator. In this case, no or little flash gas is generated from the liquefied gas introduced into the separator.

In this situation, when a valve downstream of the separator is opened to deliver the liquefied gas from the separator to the storage tank, this can cause a sudden drop in pressure in the separator, making it difficult to control the pressure in the separator.

It is an aspect of the present invention to provide a reliquefaction system that can maintain a constant pressure in a separator upon delivery of reliquefied boil-off gas from the separator to a storage tank, thereby ensuring smooth delivery of the reliquefied boil-off gas to the storage tank.

### Technical Solution

In accordance with one aspect of the present invention, there is provided a boil-off gas reliquefaction system for ships, including: a compressor compressing boil-off gas generated from liquefied gas stored in a storage tank in a ship;
a reliquefaction line connecting the compressor to the storage tank and allowing the boil-off gas to be reliquefied and returned to the storage tank therealong;
a heat exchanger disposed on the reliquefaction line and cooling the boil-off gas compressed by the compressor;
a separator disposed on the reliquefaction line, separating the boil-off gas cooled by the heat exchanger into a gaseous phase and a liquid phase, and supplying separated liquefied gas to the storage tank;
a nitrogen blanket line along which nitrogen is supplied to an upstream side of the separator; and
a bypass line branched from the reliquefaction line downstream of the heat exchanger and connected to the storage tank without passing through the separator.

The boil-off gas reliquefaction system may further include: a flow meter detecting a flow rate of the nitrogen supplied to the separator along the nitrogen blanket line, wherein blanket nitrogen is supplied to the separator along the nitrogen blanket line to maintain a constant pressure in the separator, and nitrogen consumption in the separator is monitored based on the flow rate of the nitrogen detected by the flow meter such that the boil-off gas reliquefaction system is operated in a bypass operation mode in which reliquefied gas subcooled by the heat exchanger is delivered to the storage tank along the bypass line without passing through the separator, when nitrogen consumption in the separator exceeds a predetermined value.

The boil-off gas reliquefaction system may further include: a first control valve disposed on the reliquefaction line downstream of a junction between the bypass line and the reliquefaction line; and a second control valve disposed on the bypass line.

While the second control valve is opened to deliver the subcooled reliquefied gas to the storage tank along the bypass line, some of the subcooled reliquefied gas may be supplied to the separator through the first control valve and the flow rate of the nitrogen supplied to the separator may be monitored to determine whether to return the boil-off gas reliquefaction system to a normal operation mode.

The boil-off gas reliquefaction system may further include: a pressure detector detecting an internal pressure of the separator; a pressure compensation line branched from the reliquefaction line downstream of the compressor to bypass the heat exchanger and joined with the nitrogen blanket line to be connected to the upstream side of the separator; and a pressure compensation valve disposed on the pressure compensation line downstream of a junction between the pressure compensation line and the back-up line, wherein the boil-off gas or the nitrogen may be adjusted in pressure by the pressure compensation valve based on a pressure value detected by the pressure detector prior to being supplied to the separator.

The boil-off gas reliquefaction system may further include: a first shut-off valve disposed on the pressure compensation line upstream of the junction between the pressure compensation line and the nitrogen blanket line; a second shut-off valve disposed on the nitrogen blanket line; and a check valve disposed on the nitrogen blanket line downstream of the second shut-off valve to prevent backflow.

The boil-off gas reliquefaction system may further include: a refrigerant circulation unit through which refrigerant used for heat exchange with the boil-off gas in the heat exchanger is circulated, wherein the refrigerant in the refrigerant circulation unit may be nitrogen.

In accordance with another aspect of the present invention, there is provided a boil-off gas reliquefaction method for ships, wherein: boil-off gas generated from liquefied gas stored in a storage tank in a ship is compressed by a compressor;
the boil-off gas compressed by the compressor is cooled and reliquefied in a heat exchanger, is subjected to gas/liquid separation in a separator, and is returned to the storage tank;
nitrogen is supplied to an upstream side of the separator along a nitrogen blanket line to maintain a constant pressure in the separator; and
a flow rate of the nitrogen supplied to the separator is detected to monitor nitrogen consumption in the separator such that subcooled reliquefied gas from the heat exchanger is delivered to the storage tank along a bypass line without passing through the separator, when nitrogen consumption in the separator exceeds a predetermined value.

While the subcooled reliquefied gas is delivered from the heat exchanger to the storage tank along the bypass line, some of the subcooled reliquefied gas may be supplied to the separator and the flow rate of the nitrogen supplied to the separator may be monitored to determine whether to return a boil-off reliquefaction system to a normal operation mode.

### Advantageous Effects

The boil-off gas reliquefaction system according to the present invention can provide an enhanced reliquefaction rate by more effectively cooling boil-off gas to be reliquefied using cold heat from the boil-off gas itself and cold heat in a refrigerant cycle.

In particular, even when subcooled liquefied gas is introduced into a separator and thus there is little or no flash gas generated in the separator, the boil-off gas reliquefaction system can maintain a constant pressure in the separator through supply of blanket nitrogen to the separator, thereby ensuring smooth delivery of liquefied gas from the separator to the storage tank and thus stable system operation.

In addition, when the blanket nitrogen in the separator is excessively dissolved due to subcooling of reliquefied gas, the boil-off gas reliquefaction system can reduce nitrogen consumption by delivering subcooled reliquefied gas directly to the storage tank along a bypass line bypassing the separator while supplying some of the subcooled reliquefied gas to the separator and monitoring the flow rate of the blanket nitrogen to determine whether to return the boil-off gas reliquefaction system to a normal operation mode. As a result, it is possible to reduce the required capacity and operating costs of equipment for supplying nitrogen to a ship while solving the problem of deterioration in calorific value and quality of liquefied gas due to a large amount of nitrogen being dissolved in reliquefied gas.

### DESCRIPTION OF DRAWINGS

FIG. 1 is a schematic block diagram of a boil-off gas reliquefaction system for ships according to one embodiment of the present invention.

### EMBODIMENTS

In order to fully appreciate the operational advantages of the present invention and the objectives achieved by practicing the present invention, reference should be made to the accompanying drawings, which illustrate preferred embodiments of the present invention, and description thereof.

Hereinafter, exemplary embodiments of the present invention will be described in detail in terms of the features and effects thereof with reference to the accompanying drawings. It should be noted that like components will be denoted by like reference numerals throughout the specification and the accompanying drawings.

As used herein, the term “ship” may refer to any type of ship that is provided with a liquefied gas storage tank. For example, the ship may include self-propelled vessels, such as an LNG carrier, a liquid hydrogen carrier, and an LNG regasification vessel (RV), as well as non-self-propelled floating offshore structures, such as an LNG floating production storage and offloading (FPSO) unit and an LNG floating storage regasification unit (FSRU).

In addition, the embodiments of the present invention may be applied to a reliquefaction cycle for any type of liquefied gas that can be transported in a liquid state by liquefaction at cryogenic temperatures and can generate boil-off gas during storage. For example, such liquefied gas may include liquefied petrochemical gas, such as liquefied natural gas (LNG), liquefied ethane gas (LEG), liquefied petroleum gas (LPG), liquefied ethylene gas, and liquefied propylene gas. In the following embodiments, the present invention will be described using LNG, which is a typical liquefied gas, as an example.

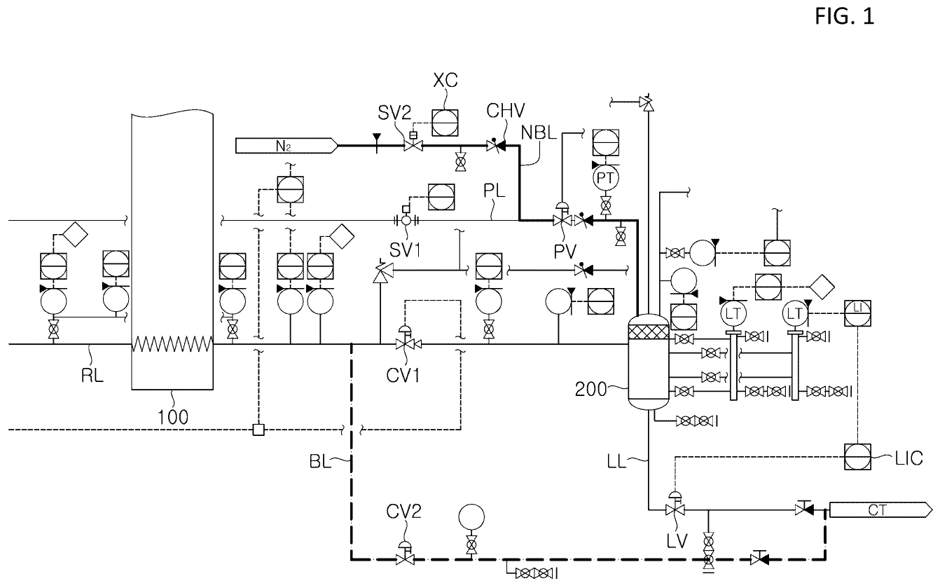

FIG. 1 is a schematic block diagram of a boil-off gas reliquefaction system for ships according to one embodiment of the present invention.

Referring to FIG. 1, the boil-off gas reliquefaction system according to this embodiment is a system for reliquefying boil-off gas generated in a liquefied gas storage tank T in a ship and returning the reliquefied boil-off gas to the storage tank T, and includes a reliquefaction line RL for supplying boil-off gas generated in the storage tank to a compressor to compress the boil-off gas, supplying the compressed boil-off gas from the compressor to a heat exchanger 100 to cool and reliquefy the compressed boil-off gas, and returning the reliquefied boil-off gas to the storage tank.

Uncompressed boil-off gas from the storage tank is supplied to the compressor after supplying cold heat to the heat exchanger. The compressor may compress the boil-off gas to, for example, a fuel supply pressure required for a main engine of the ship. For example, the compressor may compress the boil-off gas to a pressure of 5.5 barg for a DF engine, 15 barg for an X-DF engine, and 300 barg for an ME-GI engine. The compressed boil-off gas may be supplied as fuel to the main engine (not shown) of the ship. Surplus compressed boil-off gas may be reliquefied.

Classification societies require that a compressor supplying fuel to an engine be designed with redundancy in case of emergency. Accordingly, although one compressor is shown in FIG. 1, the compressor may include a main compressor and a redundant compressor.

The compressed boil-off gas from the compressor is introduced into the heat exchanger 100 along the reliquefaction line RL to be cooled through heat exchange. Here, the boil-off gas to be reliquefied may be further compressed prior to being cooled in the heat exchanger if necessary to increase a reliquefaction rate thereof.

The reliquefaction line RL is provided with: a heat exchanger 100 cooling the compressed boil-off gas from the compressor; and a separator 200 separating the cooled boil-off gas from the heat exchanger into a gaseous phase and a liquid phase and supplying separated liquefied gas to the storage tank. If necessary, a decompressor (not shown) may be disposed between the heat exchanger and the separator to decompress the boil-off gas cooled through heat exchange.

In the heat exchanger 100, the boil-off gas is cooled through heat exchange with refrigerant circulated through a refrigerant circulation unit (not shown).

The refrigerant circulation unit may include a refrigerant circulation line (not shown) along which the refrigerant is circulated, wherein the refrigerant circulation line may include: a compander expander (not shown) expanding and cooling the refrigerant to be supplied to the heat exchanger; a compander compressor (not shown) compressing the refrigerant discharged from the heat exchanger using expansion energy of the refrigerant transmitted from the compander expander; and a motor (not shown) driving the compander compressor. The compander compressor and the compander expander may be connected to each other via a common shaft such that expansion energy of the refrigerant can be utilized to compress the refrigerant, thereby reducing power required to drive a refrigerant cycle.

The refrigerant supplied to the heat exchanger while circulating along the refrigerant circulation line may be, for example, nitrogen (N₂). Nitrogen refrigerant compressed by the compander compressor is cooled by the heat exchanger, expanded and cooled by the compressor expander, and supplied back to the heat exchanger 100 while circulating along the refrigerant circulation line.

A liquid level control valve LV is disposed on the reliquefaction line RL downstream of the separator 200 to open/close the reliquefaction line RL to control delivery of reliquefied gas separated by the separator to the storage tank T. Opening the liquid level control valve LV downstream of the separator to deliver the reliquefied gas from the separator 200 to the storage tank can cause changes in pressure in the separator. Here, the pressure in the separator can be maintained at a constant level by flash gas generated from the reliquefied gas introduced into the separator.

However, depending on the composition of boil-off gas generated in the storage tank, especially if the nitrogen content of the boil-off gas is low, the reliquefied gas is subcooled through heat exchange with the nitrogen refrigerant in the heat exchanger before being introduced into the separator, resulting in little or no flash gas being generated from the reliquefied gas introduced into the separator.

Here, when the liquid level control valve downstream of the separator is opened, this can cause a sudden drop in pressure in the separator, making it difficult to control the pressure in the separator. The boil-off gas reliquefaction system according to this embodiment is further configured to compensate for such pressure variations in the separator to maintain a constant pressure in the separator.

Specifically, the boil-off gas reliquefaction system according to this embodiment further includes: a pressure compensation line PL branched from the reliquefaction line RL downstream of the compressor and connected to an upstream side of the separator 200; and a nitrogen blanket line NBL along which blanket nitrogen is supplied to the pressure compensation line, such that compressed gas or blanket nitrogen is supplied to the separator along the pressure compensation line PL upon delivery of liquefied gas from the separator to the storage tank, thereby maintaining a constant pressure in the separator.

The boil-off gas reliquefaction system according to this embodiment further includes: a pressure detector PT detecting a pressure in the separator; a liquid level detector LT to detecting a liquid level in the separator; a pressure compensation valve PV disposed on the pressure compensation line PL downstream of a junction between the pressure compensation line PL and the nitrogen blanket line NBL; and a first shut-off valve SV1 disposed on the pressure compensation line PL upstream of the junction between the pressure compensation line PL and the nitrogen blanket line NBL. In addition, the nitrogen blanket line NBL is provided with a second shut-off valve SV2 and a check valve CHV disposed downstream of the second shut-off valve to prevent backflow.

Depending on the detected pressure in the separator, boil-off gas or nitrogen is adjusted in pressure by the pressure compensation valve PV prior to being supplied to the upstream side of the separator 200 along the pressure compensation line PL. When one of the first shut-off valve SV1 and the second shut-off valve SV2 is open, the other is closed, thereby allowing either boil-off gas or nitrogen to be supplied to the separator.

Nitrogen to be supplied to the separator along the nitrogen blanket line NBL may be supplied from a N₂ buffer tank of an N₂ supply system on the shipside, or from an N₂ inventory system that supplies/replenishes nitrogen refrigerant circulated through the refrigerant circulation unit.

When the boil-off gas is supplied to the upstream side of the separator along the pressure compensation line PL, the boil-off gas is dissolved in liquefied gas in the separator until being saturated, while the liquefied gas undergoes phase transition from the subcooled state as the temperature thereof gradually increases. When the liquefied gas in this state is delivered from the separator to the storage tank, the amount of flash gas generated increases due to a pressure difference.

When the blanket nitrogen is supplied to the separator along the nitrogen blanket line NBL, the blanket nitrogen is not well dissolved in liquefied gas in the separator due to a lower liquefaction temperature thereof than methane, thereby allowing pressure compensation and continuous subcooling operation while reducing the amount of flash gas generated in the storage tank.

In this embodiment, supply of the boil-off gas or the nitrogen to the separator along the pressure compensation line does not need to be performed at all times. That is, when subcooled liquefied gas is introduced into the separator and thus little or no flash gas is generated in the separator, making it difficult to maintain a constant pressure in the separator with flash gas alone upon opening the liquid level control valve LV, the boil-off gas or the nitrogen may be supplied to the separator along the pressure compensation line to maintain a constant pressure in the separator.

However, through simulation and actual experiments on the reliquefaction system, the inventors of the present invention have confirmed that supply of the blanket nitrogen to the upstream side of the separator along the nitrogen blanket line NBL cannot ensure smooth delivery of liquefied gas to storage tank due to the fact that more nitrogen than expected is dissolved in subcooled reliquefied gas from the heat exchanger, resulting in increase in consumption of the blanket nitrogen.

In order to solve this problem, changing a temperature to which compressed gas is cooled in the heat exchanger may be considered. However, this can introduce another problem of not fully utilizing cold heat (cold power) in a reliquefaction cycle and thus reducing reliquefaction efficiency. In addition, installing separate equipment, such as a delivery pump, to ensure smooth delivery of liquefied gas to the storage tank in the event of pressure drop in the separator due to dissolution of the blanket nitrogen can increase CAPEX.

In order to solve these problems, the boil-off gas reliquefaction system according to this embodiment further includes: a bypass line BL extending from the heat exchanger 100 and connected directly to the storage tank CT without passing through the separator 200, such that subcooled reliquefied gas can be delivered directly to the storage tank CT along the bypass line BL when the blanket nitrogen is excessively dissolved in reliquefied gas, making it difficult to smoothly deliver the reliquefied gas from the separator to the storage tank or when the amount of nitrogen consumed as the blanket nitrogen becomes excessive.

Specifically, referring to FIG. 1, the boil-off gas reliquefaction system further includes: a bypass line BL branched from the reliquefaction line RL downstream of the heat exchanger 100 and connected to the storage tank CT without passing through the separator 200; a first control valve CV1 disposed on the reliquefaction line downstream of a junction between the reliquefaction line and the bypass line; and a second control valve CV2 disposed on the bypass line.

Under the control of a controller XC, the second shut-off valve SV2 is opened to supply the blanket nitrogen along the nitrogen blanket line NBL to maintain a constant pressure in the separator 200 and a flow rate of the nitrogen supplied to the separator along the nitrogen blanket line is detected by a flow meter (not shown). The flow rate of nitrogen detected by the flow meter is used to monitor the amount of nitrogen consumed by being dissolved in liquefied gas in the separator.

When nitrogen consumption in the separator 200 exceeds a predetermined value, the boil-off gas reliquefaction system is switched to a bypass operation mode and the second control valve CV2 is opened such that subcooled reliquefied gas from the heat exchanger is delivered directly to the storage tank CT along the bypass line BL without passing through the separator 200.

However, as the boil-off gas reliquefaction system continues to be operated in the bypass operation mode, reliquefied gas in a gas-liquid mixed state can be delivered to the storage tank, causing increase in pressure in the storage tank. Accordingly, when the boil-off gas reliquefaction system is operated in the bypass operation mode in which reliquefied gas from the heat exchanger is delivered to the storage tank, a small amount of cooled reliquefied gas from the heat exchanger is supplied to the separator through adjustment of the first control valve CV1 and the flow rate of nitrogen supplied to the separator is monitored to check consumption of the blanket nitrogen to determine whether to return the boil-off gas reliquefaction system to a normal operation mode.

As described above, in the boil-off gas reliquefaction system according to this embodiment, when a predetermined amount or more of the blanket nitrogen is dissolved in reliquefied gas in the separator and thus the amount of the blanket nitrogen required to maintain a constant pressure in the separator becomes excessive, reliquefied gas from the heat exchanger is sent directly to the storage tank along the bypass line, thereby ensuring smooth delivery of the reliquefied gas to the storage tank and reduction in nitrogen consumption for N₂ blanketing. As a result, it is possible to reduce the required capacity and operating costs of equipment for supplying nitrogen to a ship while solving the problem of deterioration in calorific value and quality of liquefied gas due to a large amount of nitrogen being dissolved in reliquefied gas.

Although some embodiments have been described herein, the present invention is not limited to the above embodiments and may be practiced in various modifications or variations without departing from the technical spirit of the invention, as will be apparent to one of ordinary skill in the art to which the present invention pertains.

1. A boil-off gas reliquefaction system for ships, comprising:
a compressor compressing boil-off gas generated from liquefied gas stored in a storage tank in a ship;
a reliquefaction line connecting the compressor to the storage tank and allowing the boil-off gas to be reliquefied and returned to the storage tank therealong;
a heat exchanger disposed on the reliquefaction line and cooling the boil-off gas compressed by the compressor;
a separator disposed on the reliquefaction line, separating the boil-off gas cooled by the heat exchanger into a gaseous phase and a liquid phase, and supplying separated liquefied gas to the storage tank;
a nitrogen blanket line along which nitrogen is supplied to an upstream side of the separator; and
a bypass line branched from the reliquefaction line downstream of the heat exchanger and connected to the storage tank without passing through the separator.

2. The boil-off gas reliquefaction system according to claim 1, further comprising:
a flow meter detecting a flow rate of the nitrogen supplied to the separator along the nitrogen blanket line,
wherein blanket nitrogen is supplied to the separator along the nitrogen blanket line to maintain a constant pressure in the separator, and
nitrogen consumption in the separator is monitored based on the flow rate of the nitrogen detected by the flow meter such that the boil-off gas reliquefaction system is operated in a bypass operation mode in which reliquefied gas subcooled by the heat exchanger is delivered to the storage tank along the bypass line without passing through the separator, when nitrogen consumption in the separator exceeds a predetermined value.

3. The boil-off gas reliquefaction system according to claim 2, further comprising:
a first control valve disposed on the reliquefaction line downstream of a junction between the bypass line and the reliquefaction line; and
a second control valve disposed on the bypass line.

4. The boil-off gas reliquefaction system according to claim 3, wherein, while the second control valve is opened to deliver the subcooled reliquefied gas to the storage tank along the bypass line, some of the subcooled reliquefied gas is supplied to the separator through the first control valve and the flow rate of the nitrogen supplied to the separator is monitored to determine whether to return the boil-off gas reliquefaction system to a normal operation mode.

5. The boil-off gas reliquefaction system according to claim 3, further comprising:
a pressure detector detecting an internal pressure of the separator;
a pressure compensation line branched from the reliquefaction line downstream of the compressor to bypass the heat exchanger and joined with the nitrogen blanket line to be connected to the upstream side of the separator; and
a pressure compensation valve disposed on the pressure compensation line downstream of a junction between the pressure compensation line and the nitrogen blanket line,
wherein the boil-off gas or the nitrogen is adjusted in pressure by the pressure compensation valve based on a pressure value detected by the pressure detector prior to being supplied to the separator.

6. The boil-off gas reliquefaction system according to claim 5, further comprising:
a first shut-off valve disposed on the pressure compensation line upstream of the junction between the pressure compensation line and the nitrogen blanket line;
a second shut-off valve disposed on the nitrogen blanket line; and
a check valve disposed on the nitrogen blanket line downstream of the second shut-off valve to prevent backflow.

7. The boil-off gas reliquefaction system according to claim 1, further comprising:
a refrigerant circulation unit through which refrigerant used for heat exchange with the boil-off gas in the heat exchanger is circulated,
wherein the refrigerant in the refrigerant circulation unit is nitrogen.

8. A boil-off gas reliquefaction method for ships, wherein:
boil-off gas generated from liquefied gas stored in a storage tank in a ship is compressed by a compressor;
the boil-off gas compressed by the compressor is cooled and reliquefied in a heat exchanger, is subjected to gas/liquid separation in a separator, and is returned to the storage tank;
nitrogen is supplied to an upstream side of the separator along a nitrogen blanket line to maintain a constant pressure in the separator; and
a flow rate of the nitrogen supplied to the separator is detected to monitor nitrogen consumption in the separator such that subcooled reliquefied gas from the heat exchanger is delivered to the storage tank along a bypass line without passing through the separator, when nitrogen consumption in the separator exceeds a predetermined value.

9. The boil-off gas reliquefaction method according to claim 8, wherein, while the subcooled reliquefied gas is delivered from the heat exchanger to the storage tank along the bypass line, some of the subcooled reliquefied gas is supplied to the separator and the flow rate of the nitrogen supplied to the separator is monitored to determine whether to return a boil-off reliquefaction system to a normal operation mode.
